(19) United States
(12) Patent Application Publication
(10) Pub. No.: US 2007/0196111 A1
(43) Pub. Date: Aug. 23, 2007

(54) Optic fiber network communication system with duobinary transceiver

(76) Inventor: Song Quan Shang, Palo Alto, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/361,175

(22) Filed: Feb. 23, 2006

(51) Int. Cl. H04B 10/12

(52) U.S. Cl. 398/147

(57) ABSTRACT

An optic fiber network communication system is described that allows a duobinary transceiver to be coupled with an optical dispersion compensator receiver. In one example an optical dispersion compensator is coupled to an input optical fiber to receive an optical signal and compensate the optical dispersion of the received optical signal, the optical dispersion compensator being configured to compensate the dispersion of a partial response modulation and coding transmitter. A photodetector converts the dispersion compensated optical signal to an electrical signal, and a demultiplexer demultiplexes the electrical signal.

### BACKGROUND

1. Field

The present description relates to the field of optical fiber communication networks and, in particular, to a combination of a duobinary transmitter with a tunable optical dispersion compensator receiver.

2. Description of Related Art

Current, DWDM (Dense Wavelength Division Multiplexing) long-haul fiber optic networks are built for line speeds of 10 Gb/s (10 Gigabits per second). Long haul networks have been augmented with PON's (Passive Optical Network) that have rapidly been deployed in local residential areas. New 10 GbE (10 Gigabit Ethernet) networks are also being deployed to enterprise environments. The new faster network designs can support higher speed service to all types of users creating a demand to further improve the speed and the dispersion tolerance of intermediate metropolitan networks. This can mitigate bottle-neck issues in existing metropolitan networks which is critical for future high bandwidth applications such as video distribution.

Optical duobinary coding has been used to improve fiber chromatic dispersion tolerance at high-speed data rates. While duobinary coding is relatively easy to implement with a 2×Vπ modulation using a MZM (Mach-Zehnder Modulator) in a transmitter, the technique has not yet been deployed on a large commercial scale.

However, when used in an uncompensated metro optical network, the BtB (back-to-back) performance from duobinary coding suffers a penalty of about 2 dB compared to a NRZ (Non-Return to Zero) binary coding counterpart because of the ISI (Inter-Symbol Interference) generated by the duobinary coding. This ISI reduces the data rate by about one-fourth. In addition, the link budget for the 2 dB (decibel) path-penalty caused by optical duobinary coding is limited to about ±3200 ps/nm (picoseconds per nanometer) at 10 Gb/s (Gibabits per second). This is less than an extended-metro link with a 2.5 Gb/s data rate transmitted over a 300 km (kilometer) SMF (Single Mode Fiber).

Recent developments in MLPE (Maximum Likelihood Optimal Sampling Phase Estimation) and MLSE (Maximum Likelihood Sequence Estimation) receivers have demonstrated an improved link budget for duobinary transmission to about 4000 ps/nm. However, this minor improvement requires a significant increase in cost, complexity, and power consumption. These factors may be significant in a transponder-type subsystem package.

### BRIEF DESCRIPTION OF THE DRAWINGS

Embodiments of the present invention will be understood more fully from the detailed description given below and from the accompanying drawings of various embodiments of the invention. The drawings, however, should not be taken to be limiting, but are for explanation and understanding only.

FIG. 1 is a block diagram of a duobinary optical transmitter according to an embodiment of the invention;

FIG. 2 is a block diagram of a tunable optical receiver according to an embodiment of the invention;

FIG. 3 is a process flow diagram of tuning and maintaining the receiver of FIG. 2 according to an embodiment of the invention; and

FIG. 4 is a block diagram of optical networks according to an embodiment of the invention.

### DETAILED DESCRIPTION

A 10 Gb/s duobinary transmitter may be combined with a TODC (Tunable Optical Dispersion Compensator) at a receiver to provide an existing DWDM network with a dispersion tolerance beyond 400 km using uncompensated SMF (Single Mode Fiber). This technical advance may be applied to 10 G commercial duobinary transponders to achieve unprecedented OSNR (Optical Signal to Noise Ratio) performance and to reach dispersion tolerance beyond 7200 ps/nm fiber links. Compared to other techniques such as MLPE, MLSE, and EDC (Electrical Dispersion Compensation) receivers, performance may be higher with lower cost and simpler implementation. Such a receiver may easily be designed into, for example, a 300-pin MSA (Multi Source Agreement Group) module. The resulting system and process may be used in many applications including extended metro, ROADM (Reconfigurable Optical Add/Drop Multiplexers) and long-haul networks.

In one embodiment of the invention, ODC (Optical Dispersion Compensation) is used to overcome the ISI penalty normally expected from duobinary coding and to improve dispersion tolerance. OSNR performance may be restored to a level similar to that associated with a high performance NRZ binary coding transponder.

Duobinary coding may be considered as a pseudotemary format example of partial response modulation and coding. The output sequence is in the form of symbols that may be any of three different states, such as (0, 1, 2) or (−1, 0, +1). This may reduce the bandwidth required to carry a particular data stream in half with only a modest increase in the complexity of the coder and decoder. Duobinary encoding devices can be realized either by a delay-and-add filter using a delay line or by a duobinary filter, i.e. a low-pass filter with, e.g. a 3-dB cut-off frequency of about ¼ the bit rate. Suitable partial response modulation and coding may be implemented in a variety of different ways.

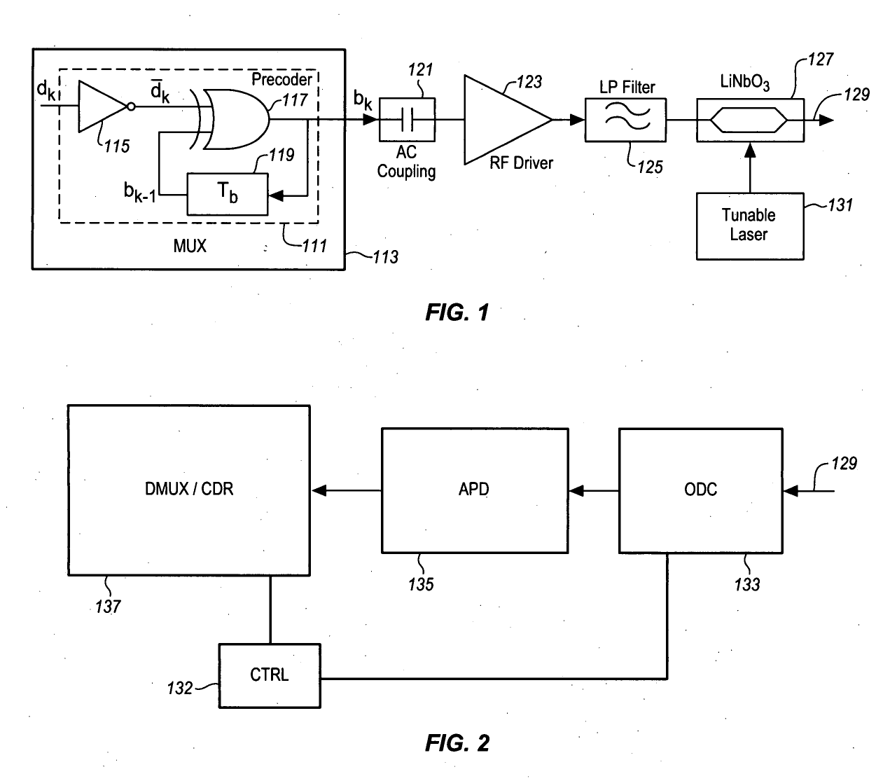

FIG. 1 shows an example block diagram of a duobinary transponder. The transmitter may be implemented as a full C-band tunable duobinary transponder in accordance with the 300-pin MSA group platform. In the illustrated example, a duobinary precoder 111 is integrated within a multiplexer 113, such as a 16-bit MUX. The duobinary precoder may have any of a variety of different designs. In the illustrated example, the input data dk is received at an inverter line stage 115 and coupled to an XOR (Exclusive OR) gate. The XOR output bₖ is the partial response encoded sequence that is used as the output of the MUX. It is also used as a feedback through a delay device, such as a T_{b} flip-flop 119 back to a second input of the XOR. The delayed input to the XOR is bₖ₋₁. The delay may be fixed or adjustable depending on the application. Other devices may be added to the precoder that are not shown including inverters, amplifiers and other logic. A suitable duobinary transmitter that uses such a precoder is a TXN13600 10 Gbps Tunable DWDM Optical Transceiver available from Intel Corp. However, other duobinary transmitter components may alternatively be used.

The output from the MUX 113 is coupled to an AC (Alternating Current) coupler 121, for example a capacitor with excellent frequency characteristics. The coupled signal is sent to a RF (Radio Frequency) driver 123. The amplified RF signal goes through a low-pass filter 125 and then is applied to a MZM (Mach-Zehnder Modulator) 127, typically a LiNbO₃ (Lithium Niobate) waveguide with magnetic field effects. In one example, the waveguide is biased at the null of the transfer function. The low pass filter may be integral with the MZM or external to the MZM. A 10Vₚₚ swing from the RF driver is more than sufficient to drive a typical single-ended MZM. A tunable laser 131 input to the MZM may be used to fine tune the MZM output 129 for the best transmission properties. For example, it may be used to select the output wavelength on a DWDM grid. With proper adjustment of the tunable laser and the MZM's DC bias, the duobinary output 129 may be made to show a typical optical eye with extinction ratio of 10.8 dB and RMS (Root Mean Square) jitter<4.0 ps. The particular parameters used may be adjusted obtain the results best suited to suit different implementations and different applications. The MZM output may be coupled to a fiber optic transmission line (not shown) to be carried to a receiver.

FIG. 2 shows a block diagram of a receiver chain that includes an ODC (Optical Dispersion Compensator) block 133 to receive the optical signal 129 from the transmission line, an APD (Avalanche Photodiode) block 135 to convert the optical signal to an electrical signal and a DMUX/CDR (Demultiplexer/Clock Data Recovery) block 137. In addition, a controller 132 coupled to the ODC and the DMUX/CDR initializes and tunes the devices for optimum settings. The controller may also provide other functions depending on the application. The controller may be an external device as shown or integrated into the DMUX/CDR or ODC. The ODC may be a tunable ODC (TODC) with four independent etalons each with a 50 GHz free spectrum range. Each etalon may have an independently adjustable wavelength discriminator filter. This may allow for a different wavelength discriminator characteristic for each etalon and each etalon may be independently adjustable.

A suitable TODC is a Free-Path™ TODC from Civcom, Inc. However, other ODC's may alternatively be used. Such a TODC has a maximum insertion loss of <1.5 dB, and, in the present example, is hermetically sealed into a butterfly package (22 mm×12.7 mm×9.5 mm). This TODC allows the chromatic dispersion to be adjusted with a step of 100 ps/nm and the maximum tuning range is over ±2000 ps/rm using embedded heaters at ITU (International Telecommuications Union) grid over the full C-band or L-band. The TODC described above allows sufficient range for a wide range of transceivers and DWDM networks, however, the particular specifications provided above are provided only as an example. The tuning range, if any, may be selected to suit a particular application and may be different from that described above.

The APD (Avalanche Photodetector) may be used to apply a square law characteristic detection to convert the received, compensated duobinary signal back to an NRZ binary coded signal. Since the duobinary code generated at the transmitter has used the MZM bias at null, the pseudoternary ±1 states have the same output amplitude but opposite phase. Therefore the square detection converts the duobinary code back into NRZ binary code automatically. The APD may have an integrated TIA (trans-impedance amplifier) to provide a wide dynamic range. The TODC may also be integrated with the APD in the receiver.

The DMUX/CDR block may be a 16-bit demultiplexer for NRZ binary code with a built in CDR. The DMUX/CDR demultiplexes and recovers the NRZ waveform to a digital data stream that is ready to be processed by a framer. From the framer, the data stream may be suitable for transmission over wired networks or for remodulation onto an optical network. With offset control at the input of the DMUX, the RxDTV (Receiver Decision Threshold Voltage) may be enhanced further.

Duobinary transmission tends to be dispersion tolerant since its power spectrum density has a much narrower bandwidth as compared, for example, to NRZ coded transmission. A transmission link up to ±3400 ps/nm may be achieved with duobinary coding. In some networks, the sweet spot of a duobinary transmission system happens at a link at around ±2000 ps/nm when the ISI distortion from duobinary coding is fully compensated by the chromatic dispersion of the optical fiber carrier. However, one of the disadvantages of duobinary coding is that it may have a BtB (Back to Back) penalty due to a low Tb/4 bandwidth. The Tb/4 bandwidth tends to fail the Nyquist requirement for signal communications through the fiber. Accordingly, the OSNR of a signal received from a duobinary transmitter must be higher than for a signal from a NRZ receiver to obtain the same BER. In addition, post compensation with an EDC (Electrical Dispersion Compensation) has been ineffective for duobinary coding even with very complex designs for the EDC.

The TODC may be preset at a fixed value for a particular point-to-point link, or it may be dynamically adjusted using FEC (Forward Error Correction) corrected blocks as a feedback input. A TODC may take only a few seconds to locate an optimal value from any condition. Alternatively an ODC that is not tunable may be used if it has an appropriate amount of compensation or is configured for an appropriate amount for its intended application.

The TODC may be used to tune the aggregated chromatic dispersion of the transmission system (including the duobinary precoder, the fiber and the TODC) to a sweet spot (typically in the range of ±2000 ps/nm) for the particular duobinary transmitter and the communication path. The tuning may be used to allow the BtB (back-back) degradation due to ISI to be compensated. As a result, the OSNR performance of the duobinary system may be recovered back to the level of a NRZ binary coding counterpart. The tuning also allows the transmission link to be extended an additional 4000 ps/nm over what has traditionally been allowed by duobinary coder.

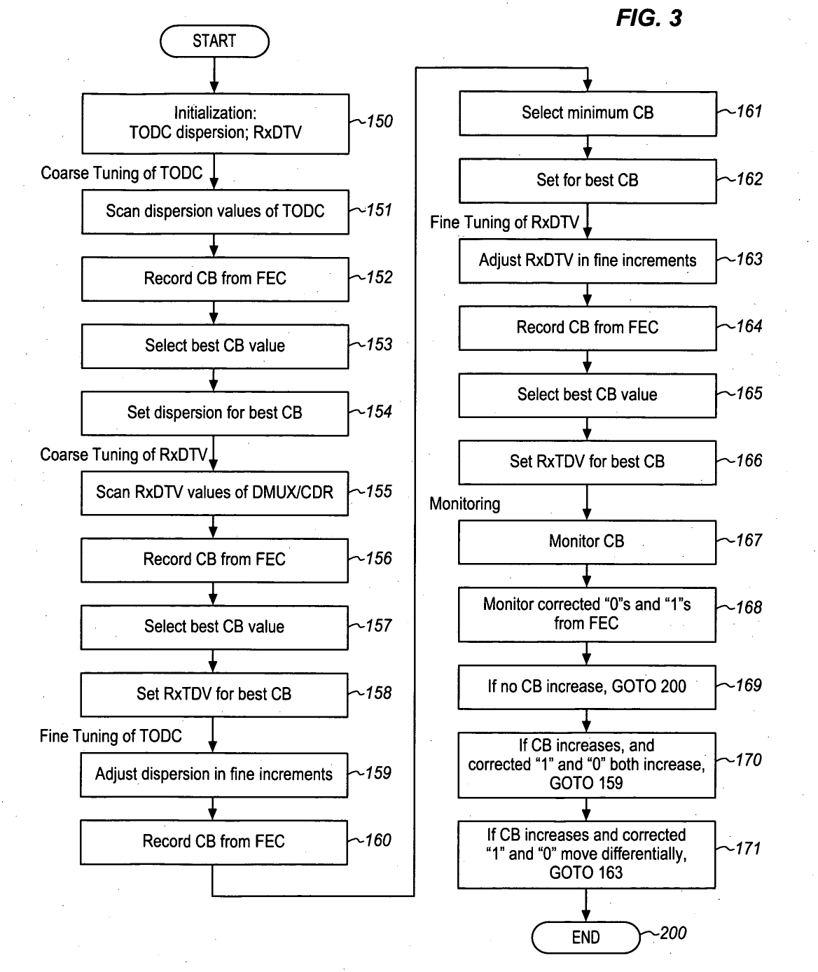

FIG. 3 shows a sequence of operations that may be used to find an optimal setting for a TODC and to maintain tuning during operation. The tuning operations described below may be performed by the external controller 132, or by another connected device. In FIG. 3, at block 150, the initial chromatic dispersion of a TODC is set. The initialization value may be selected based on estimates of the actual installation or some average or middle value. In the present example, the chromatic dispersion is set at 2000 ps/nm and the RxDTV (receiver decision threshold voltage) is set at 50%. For a BtB link, these settings may be approximately correct.

After initialization, a coarse tuning process may be applied. At block 151, the dispersion values of the TODC are scanned. At block 152, the CB (corrected blocks) from FEC (Forward Error Correction) are recorded for each dispersion value. Alternatively, another indication of the quality of the received signal may be used for example BER (Bit Error Rate), OSNR or other measures. At block 153, the best error or signal quality value is chosen. For FEC, this is typically the minimum CB value. The particular value selected as best may depend on the type of signal quality measure that is used. At block 154, the TODC is set to the dispersion value which corresponds to the best signal quality, for example, the minimum CB during the scan.

After or before the coarse tuning setting for TODC dispersion, coarse tuning may be performed for RxDTV. At block 155, the RxDTV values of the DMUX/CDR are scanned and at block 156, the CB from FEC is recorded for each RxDTV value. As with the TODC tuning, other measures, such as BER may be recorded during the scan. The CB or other measure corresponding to the best signal quality is selected at block 157. For the CB example, the best value may be the minimum CB. At block 158, the RxDTV is set to the voltage value which corresponds to the minimum CB obtained during the scan.

Dispersion may also be fine-tuned. Better results may be obtained if all fine-tuning is performed after coarse tuning. However, the dispersion may be fine-tuned before tuning RxDTV, or fine tuning may be skipped altogether. Alternatively, the TODC may be coarse tuned or preset prior to installation so that coarse tuning is not necessary and only fine tuning is performed. At block 159, the dispersion is adjusted in fine increments and at block 160, the CB is recorded for each increment. At block 161, the minimum CB is selected among the fine increments and at block 162, the dispersion is set for the best CB value. The fine-tuning process is similar to the coarse tuning process and the same variations and modifications may be performed as described above.

Similarly, the RxDTV may also be fine-tuned. In the present example, dispersion and then RxDTV are coarse tuned and then dispersion and RxDTV are fine tuned. However, any one or more tuning operations may be skipped, RxDTV may be tuned before dispersion, and one value may be coarse and fine tuned before the other value is tuned. At block 163, the RxDTV values of the DMUX/CDR are scanned in fine increments and at block 164, the CB from FEC is recorded for each RxDTV value. As with the coarse tuning, other measures, may alternatively be recorded. The CB corresponding to the best signal quality is selected at block 165, and at block 166, the RxDTV is set to the voltage value which corresponds to the minimum CB obtained during the scan.

As the network system operating environment changes, the noise levels in the connected equipment and physical nature of the fiber link may vary. The TODC dispersion and RxDTV may be maintained at optimal settings over long operation periods through a monitoring process. At block 167, the CB is monitored. In addition to CB, the corrected “0”s and “1”s from the FEC may be monitored at block 168.

The corrected “0”s and “1”s may be used to differentiate between an out of tune chromatic dispersion and an out of tune receiver decision threshold. If CB stays at or near the optimal value obtained in the tuning processes, then, as suggested at block 169, the monitoring may end or repeat after a selected time or event. On the other hand, if the CB increases and the corrected “0”s and “1” increase simultaneously this suggests that the chromatic dispersion is away from the optimal setting. As in block 170, the dispersion value of the TODC may be retuned using the fine tuning process described above. Alternatively, the coarse tuning process or both the coarse tuning and the fine tuning process may be applied.

If the corrected “0”s and “1”s move differently this suggests that the decision threshold (RxDTV) has drifted away from the selected optimal setting. The RxDTV may be retuned by repeating the coarse tuning, or the fine tuning for the RxDTV or both. The monitoring process may be repeated at timed intervals, based on an event timer or constantly. The processes described above may be applied to a wide range of different application and may be particularly well-suited to fiber link with dynamic routing. In some applications, the TODC may be calibrated at the factory for its chromatic dispersion value. This may correspond to initialization 150 mentioned above.

In the four etalon structure mentioned above, a process such as the one shown in FIG. 3 may be applied to each etalon individually. The etalons may be tuned in sequence, one after the other or simultaneously. The tuned values may be saved by embedded electronics (not shown). So after the calibration, the TODC tuning may be identified by and recorded as its chromatic dispersion's value for simplicity.)

The TODC may be calibrated at the manufacturer or by a system integrator. It may be tuned in advance of installation based on its anticipated application or it may be tuned after it is installed. With the addition of appropriate control circuitry or control ports a receiver may also be tuned while in use either automatically or during a service visit. Tuning the TODC and TxDTV during use allow changes in the condition of the fiber or the external environment to be adjusted for as well as changes in the transmitter and the ODC that may occur over time.

In some tests, using an ODC receiver, the transponder shows superior performance without any degradation using a communication path of anywhere from 0-250 km of SMF (Single Mode Fiber). This high performance is caused at least in part by tuning the ODC for the characteristics of the particular fiber. An ODC may be capable of setting the aggregated chromatic dispersion (of both the fiber and the ODC) to the sweet spot (±2400 ps/nm in some cases) for a duobinary coder. The tuning allows performance to be optimized over a wide range of optical fiber lengths and types.

In addition, test systems show no obvious BER (Bit Error Rate) floor. As a result, the duobinary transponder described above may be applied to a system with or without FEC (Forward Error Correction). When the ODC is configured under nominal conditions, the required OSNR at BtB is 13.2 dB (improved by 1.6 dB), which is equivalent to that from a high quality NRZ transponder typically used for today's long-haul networks. The ISI penalty due to duobinary coding is nearly removed. Compared to previous ODC systems, this shows more than a 4 dB OSNR improvement. The combination of duobinary precoder and TODC works over a wide dynamic range of receiver input and is insensitive to receiver noise and linearity, unlike EDC-based approaches. In addition, when a zero-chirp modulator is used for the transmitter, the OSNR performance is symmetric with respect to the positive and the negative dispersive links. Almost no path penalty is observed in test systems at up to ±5000 ps/nm and only a 2 dB path penalty happens at ±5500 ps/nm. Tuning an ODC allows the transmission link to be extended another 4000 ps/nm and this limitation is at least in part a result of the tuning range of currently available ODC's.

In brief, using the tunability of an ODC, the ISI penalty introduced by duobinary coding may be nearly removed, which leads to an OSNR performance similar to that from a high performance NRZ transponder. The dispersion tolerance at 2 dB OSNR penalty may be extended to at least ±5500 ps/nm. With an ODC under double-pass conditions, the dispersion tolerance may be extended to at least 7200 ps/nm. This technique is suitable for a wide range of applications in extended-metro, ROADM as well as future long-haul networks.

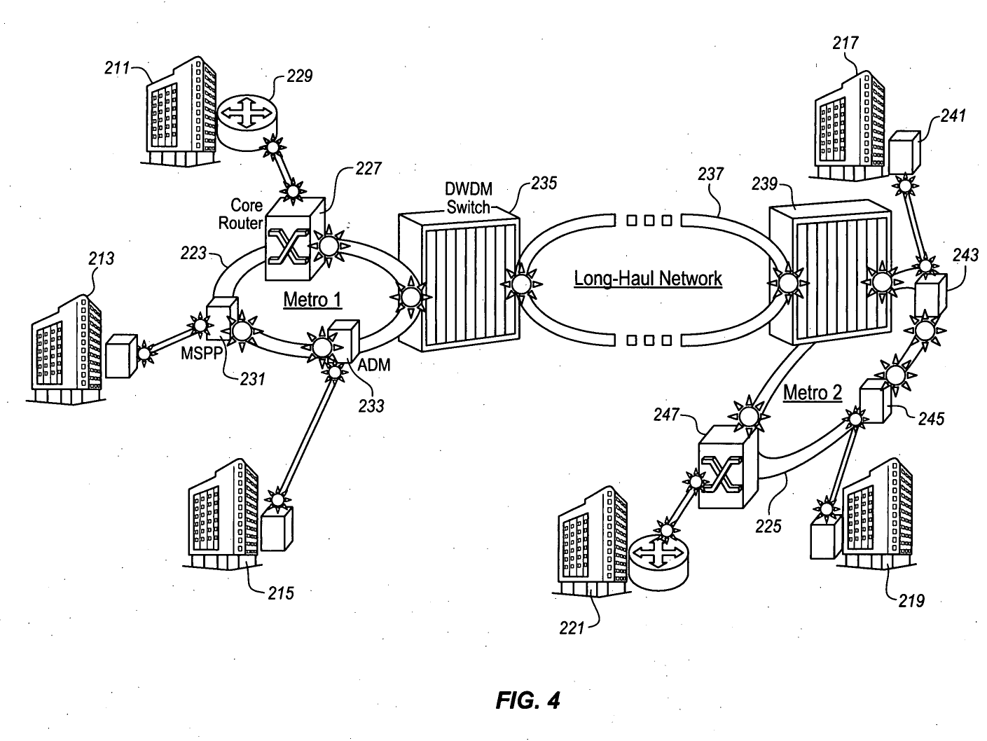

FIG. 4 is a block diagram of a fiber optic network to which the present invention may be applied. Different user groups 211, 213, 215, 217, 219, 221 are coupled to metropolitan optical fiber networks 223, 225. The metro networks 223, 225 show support for a variety of different communication connections. Metro 1 223, for example, has a core router 227 capable of connecting directly to an optical router 229 at a first user group 211. An MSPP (Multiservice Provisioning Platform) on Metro 1 provides for connection to a second user group 213 and an ADM (Add/Drop Multiplexer) 233 provides for connections to a third user group 215. All of these different types of user groups may be connected through a DWDM switch 235 to one or more long-haul networks 237. The different connections to Metro 1 are provided as examples. Not all of the connections shown must be used and other types of connections may be used as alternatives. Many more user groups may be added to Metro 1 using connections similar to those shown or using other connections. While each user group is shown as a group of co-located network tenants, a single user group may be spread over short or long distance through a variety of different wired, optical and wireless technologies.

The long-haul network is coupled to the second metropolitan optical network 225, Metro 2 through a second DWDM switch 239. Similar network access devices 241, 243, 245, 247 to those described above for Metro 1 provide access to the network for user groups. The long-haul network and metropolitan networks are typically optic fiber based. Any one or more of the user groups may also communicate through optic fiber. A transmitter and receiver, as described above, may be applied in any one or more of the routers or switches shown in FIG. 4, including the DWDMs, core routers, MSPPs, and ADMs.

A lesser or more complicated transmitter, receiver, optical network and tuning process may be used than those shown and described herein. Therefore, the configurations may vary from implementation to implementation depending upon numerous factors, such as price constraints, performance requirements, technological improvements, or other circumstances. Embodiments of the invention may also be applied to other types of systems that use different inputs and outputs than those shown and described herein.

Embodiments of the present invention may be provided as a computer program product which may include a machine-readable medium having stored thereon instructions which may be used to program a general purpose processor, embedded processor or application specific device (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and apparatus are described in their most basic form but steps may be added to or deleted from any of the methods and components may be added or subtracted from any of the described apparatus without departing from the basic scope of the present invention. It will be apparent to those skilled in the art that many further modifications and adaptations may-be made. The particular embodiments are not provided to limit the invention but to illustrate it. The scope of the present invention is not to be determined by the specific examples provided above but only by the claims below.

What is claimed is:

1. An optic fiber receiver comprising:
an optical dispersion compensator coupled to an input optical fiber to receive an optical signal and compensate the optical dispersion of the received optical signal, the optical dispersion compensator being configured to compensate the dispersion of a partial response modulation and coding transmitter;
a photodetector to convert the dispersion compensated optical signal to an electrical signal; and
a demultiplexer to demultiplex the electrical signal.

2. The receiver of claim 1, wherein the partial response modulation and coding transmitter comprises a duobinary coding transmitter.

3. The receiver of claim 1, wherein the optical dispersion compensator is also configured to compensate the dispersion of a communication path from the transmitter.

4. The receiver of claim 1, wherein the optical dispersion compensator comprises a tunable optical dispersion compensator and wherein the tunable optical dispersion compensator is configured by tuning for an expected amount of dispersion in the optical signal.

5. The receiver of claim 1, wherein the optical dispersion compensator comprises a tunable optical dispersion compensator and wherein the tunable optical dispersion compensator is configured by tuning for a desired optical signal to noise ratio.

6. The receiver of claim 1, wherein the photodetector comprises an avalanche photodiode.

7. The receiver of claim 1, wherein the partial response modulation and coding transmitter comprises a duobinary transmitter and wherein the photodetector converts the duobinary coding to non-return to zero coding.

8. A method comprising:
scanning dispersion values of a tunable optical dispersion compensator, the optical dispersion compensator being coupled to an optic fiber to receive optical signals from a partial response modulation and coding transmitter;
recording measures of the quality of the received signal for each dispersion value of the scan;
selecting a dispersion value with a high signal quality measure to compensate for the optical dispersion of the partial response modulation and coding transmitter.

9. The method of claim 8, wherein recording signal quality measures comprises recording error values from a forward error correction decoder.

10. The method of claim 8, wherein the partial response modulation and coding transmitter comprises a duobinary coder.

11. The method of claim 8, wherein the dispersion value further compensates for the communication path from the partial response modulation and coding transmitter.

12. The method of claim 8, further comprising applying a fine tuning loop to the selected dispersion values after selecting a dispersion value.

13. The method of claim 8, wherein scanning dispersion values comprises scanning dispersion values during normal operations.

14. The method of claim 8, further comprising:
scanning receiver threshold decision voltage of a demultiplexer coupled to the tunable optical compensator;
recording measures of the quality of the received signal for each voltage of the scan;
selecting a threshold decision voltage with a high signal quality measure.

15. An article comprising a machine-readable medium comprising data that when operated on by the machine cause the machine to perform operations comprising:
scanning dispersion values of a tunable optical dispersion compensator, the optical dispersion compensator being coupled to an optic fiber to receive optical signals from a partial response modulation and coding transmitter;
recording measures of the quality of the received signal for each dispersion value of the scan;
selecting a dispersion value with a high signal quality measure to compensate for the optical dispersion of the partial response modulation and coding transmitter.

16. The article of claim 15, wherein the dispersion value further compensates for the communication path from the partial response modulation and coding transmitter.

17. The article of claim 15, wherein the operations further comprise:
scanning receiver threshold decision voltage of a demultiplexer coupled to the tunable optical compensator;
recording measures of the quality of the received signal for each voltage of the scan;
selecting a threshold decision voltage with a high signal quality measure.

18. An optic fiber communications system comprising:
a network of optical fibers to communicate data signals;
an optical router coupled to the network to switch the data signals between different nodes on the network; and
an optical receiver in the router coupled to an input optical fiber having a tunable optical dispersion compensator to receive an optical signal and compensate the optical dispersion of the received optical signal, the tunable optical receiver being configured to compensate the dispersion of a duobinary coding transmitter, a photodetector to convert the dispersion compensated optical signal to an electrical signal, and a demultiplexer to demultiplex the electrical signal.

19. The method of claim 18, wherein the optical dispersion compensator is also configured to compensate the dispersion of a communication path from the transmitter.

20. The method of claim 18, wherein the tunable optical dispersion compensator is configured by tuning for a desired optical signal to noise ratio.
